(19) United States
(12) Patent Application Publication
(10) Pub. No.: US 2009/0129607 A1
(43) Pub. Date: May 21, 2009

(54) VEHICLE CALL DEVICE AND CALLING METHOD

(76) Inventor: Shinichi YAMAMOTO, Toyota-shi (JP)

Correspondence Address: KENYON & KENYON LLP, 1500 K STREET N.W., SUITE 700, WASHINGTON, DC, 20005, US

(21) Appl. No.: 12/262,638

(22) Filed: Oct. 31, 2008

(30) Foreign Application Priority Data
Nov. 16, 2007 (JP) 2007-297796

(51) Int. Cl. H04B 1/00

(52) U.S. Cl. 381/86

(57) ABSTRACT

A vehicle call device and a calling method capable of making it easier to pick up a voice of an occupant of a vehicle in an emergency situation are disclosed. The vehicle call device includes a speaker in a vehicle for outputting a received voice of an opposite party; a microphone in the vehicle for picking up a voice of an occupant of the vehicle; a detecting unit detecting an emergency situation of the vehicle; and a controlling unit, when the detecting unit detects the emergency situation, controlling directional characteristics of the microphone so that the voice can be picked up from an area wider than an area provided before the emergency situation is detected.

### CROSS-REFERENCE TO RELATED APPLICATIONS

The present application claims priority under 35 U.S.C §119 to Japanese Patent Application Publication No. 2007-297796 filed Nov. 16, 2007, the entire contents of which are hereby incorporated herein by reference.

### BACKGROUND OF THE INVENTION

1. Field of the Invention

The present invention generally relates to a vehicle call device and the like, and more particularly to a vehicle call device and a calling method using a microphone capable of adjusting its directional characteristics.

2. Description of the Related Art

Recently, more and more vehicles have been equipped with a hands-free device allowing the driver to converse while driving without directly operating a cell phone or the like. In such a case, for example, a received voice received by the cell phone is output from a speaker connected to a cell phone in the vehicle, and a transmitted voice of the driver is picked up by a microphone also connected to the cell phone. However, there is a known problem that, while driving, a road noise may also be picked up by the microphone of the hands-free device, which may degrade the voice quality. To overcome the problem, some technologies (such as described in Patent Document 1) are disclosed. According to Patent Document 1, plural microphones having omnidirectional characteristics are provided in a vehicle. Each of the microphones is selectively turned ON depending on a road noise level to produce a sensitive voice-collection area of the microphones in accordance with the driver's seat position. By doing this, when the road noise level is greater than a prescribed level, plural microphones are selected and turned ON to produce more sensitive voice-collection area around the mouth of the driver by overlapping each of the voice-collection areas of the selected microphones. As a result, a voice of the driver may be picked up more clearly.

Additionally, when such a hands-free device is used, it becomes possible to call and talk to an operator of an emergency service center without directly operating the cell phone in a case where the vehicle is involved in an accident (see, for example, Patent Document 2). Patent Document 2 discloses a technique in which a transmitted voice of an occupant of the vehicle is transmitted to an emergency service center more clearly by amplifying the transmitted voice of the occupant of the vehicle in an emergency situation.

Patent Document 1: Japanese Patent Application Publication No. 2000-83090

Patent Document 2: Japanese Patent Application Publication No. 2004-80697

However, unfortunately, the position of a driver in an emergency situation is not always the same as that in a driving situation. As a result, as the hands-free device described in Patent Document 1, when more sensitive voice-collection area is produced around the mouth of the driver assuming that the position of the driver is unchanged, it may become difficult to pick up the transmitted voice of the driver clearly. Further, when the transmitted voice of the driver cannot be adequately picked up, it may be still difficult to talk with an operator of an emergency service center even when the transmitted voice signal of the hands-free device is amplified as described in Patent Document 2.

### SUMMARY OF THE INVENTION

The present invention is made in light of the above circumstances and may provide a vehicle call device and a calling method capable of making it easier to pick up a voice of an occupant of a vehicle in an emergency situation.

According to an aspect of the present invention, a vehicle call device includes a speaker in a vehicle for outputting a received voice of an opposite party; a microphone in the vehicle for picking up a voice of an occupant of the vehicle; a detecting unit detecting an emergency situation of the vehicle; and a controlling unit, when the detecting unit detects the emergency situation, controlling directional characteristics of the microphone so that the voice can be picked up from an area wider than an area provided before the emergency situation is detected.

By doing this, it becomes possible to pick up a voice from the wider voice-collection area. Therefore, even in a case where the position of the mouth of the driver is uncertain in an emergency situation, it may become easier to clearly pick up a voice of the driver. Further, in such an emergency situation, the vehicle is most likely stopped, and accordingly the road noise may be reduced to a low level. Therefore, a voice of the driver may be picked up more clearly.

Further, according to another aspect of the invention, a vehicle call device includes a speaker in a vehicle for outputting a received voice of an opposite party; a microphone in the vehicle for picking up a voice of an occupant of the vehicle; a detecting unit detecting an emergency situation of the vehicle; and a controlling unit, when the detecting unit detects the emergency situation, controlling directional characteristics of the microphone so that the voice can be picked up from an area including an area different from an area provided before the emergency situation is detected.

By doing this, in an emergency situation, it becomes possible to pick up a voice from a voice collection area different from a voice collection area provided in a normal conversational situation. Therefore, even when the position of the mouth of the driver is uncertain, it may become easier to pick up a voice of the driver.

Further, when the detecting unit detects an emergency situation, the controlling unit controls the directional characteristics of the microphone so that the voice can be picked up from an area near the steering wheel of the vehicle.

By doing this, in an emergency situation, it becomes possible to pick up a voice of the driver clearly in a case where the driver bends his/her head over the steering wheel.

Further, according to another aspect of the invention, when the detecting unit detects an emergency situation, the controlling unit controls the directional characteristics of the microphone so that the microphone has omnidirectional characteristics.

According to this aspect of the present invention, by setting the directional characteristics of the microphone as omnidirectional, a voice of the driver may be picked up more clearly even in a case where the position of the mouth of the driver is uncertain.

According to an embodiment of the present invention, a vehicle call device and a calling method are capable of making it easier to pick up a voice of an occupant of a vehicle in an emergency situation.

### BRIEF DESCRIPTION OF DRAWINGS

Other objects, features, and advantages of the present invention will become more apparent from the following description when read in conjunction with the accompanying drawings, in which:

FIG. 1A is a drawing showing a narrow directional area (voice-collection area) in a normal conversational situation;

FIG. 1B is a drawing shown a wide directional area in an emergency situation;

FIG. 2 is a schematic drawing showing an exemplary configuration of an emergency call system;

FIG. 3 is a block diagram showing an exemplary configuration of an emergency call device according to an embodiment of the present invention;

FIG. 4 is a flowchart showing a process of adjusting a directional area (voice-collection area) of the microphone by a voice processing section according to an embodiment of the present invention; and

FIGS. 5A through 5D are drawings showing exemplary wide directional areas in an emergency situation.

### DETAILED DESCRIPTION OF THE PREFERRED EMBODIMENT

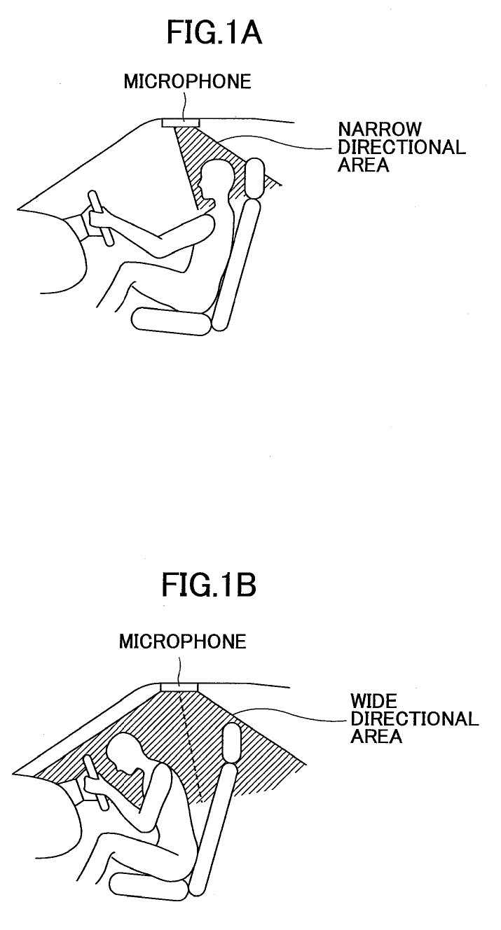

In the following, an exemplary embodiment of the present invention is described with reference to the accompanying drawings. First, an emergency call device according to an embodiment of the present invention is briefly described. FIG. 1A shows a case where the microphone in the vehicle has narrow directional characteristics (hereinafter referred to as a “directional area”) in a situation other than an emergency situation (hereinafter referred to as a “normal conversational situation”). On the other hand, FIG. 1B shows a case where the microphone has a wide directional area in an emergency situation. Herein, the directional area refers to the voice-collection area, and may be divided in two types: the narrow directional area and the wide directional area. The narrow directional area has relatively narrower area size and higher sensitivity than the wide directional area and is provided by using plural microphones. On the other hand, the wide directional area has a relatively wider area, and is provided by using one or more microphones. It should be noted that when the directionality of the microphone is not being controlled, the directional area (voice-collection area) is provided based on the directionality characteristics of the microphone(s) which is turned ON. In this embodiment, the voice-collection area when the microphone in the vehicle is not being controlled is called an “omnidirectional area”, which becomes an example of the wide directional area.

As shown in FIG. 1A, in the normal conversational situation, the driver sits in the driver's seat in a driving position to drive the vehicle. Therefore, the directional area (voice-collection area) in the normal conversational situation is the narrow directional area directed toward a slightly front side with respect to the head rest of the driver's seat, namely the mouth of the driver.

On the other hand, in an emergency situation when, for example, the vehicle is involved in an accident, the position of the driver may be different from that in the normal conversational situation. In this case, the voice of the driver may not be clearly picked up by the microphone when the narrow directional area is maintained as in the normal conversational situation.

To overcome this situation, in this embodiment, in such an emergency situation, the directional area (voice-collection area) of the microphone is changed (adjusted) from the narrow directional area to the wide directional area as shown in FIG. 1B. By doing this, it becomes possible to pick up the voice of the driver more clearly even when the position of the driver is different from that in the normal conversational situation. When the directional area becomes the wide directional area as shown in FIG. 1B, the vehicle is stopped in an emergency situation in most cases. Therefore, the road noise is at a low level, and the voice of the driver may be picked up clearly.

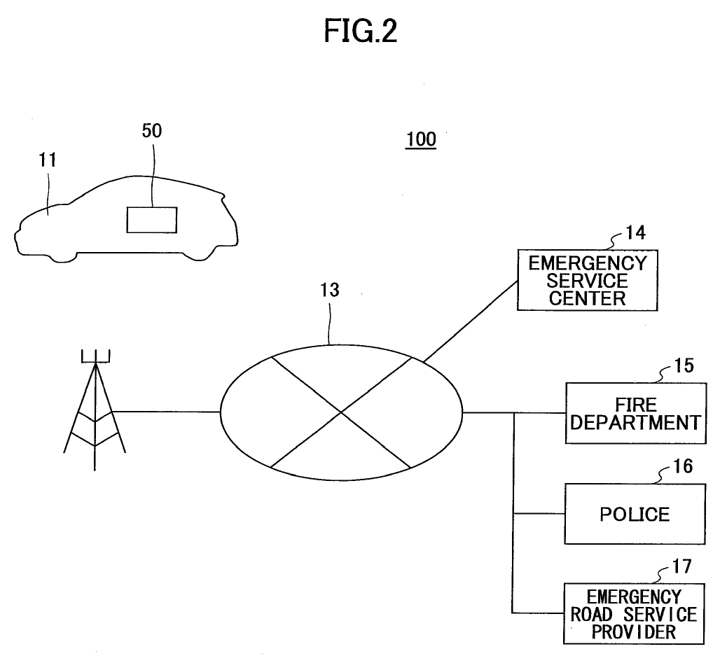

FIG. 2 schematically shows an exemplary configuration of an emergency call system 100. As shown in FIG. 2, the emergency call system 100 generally includes a vehicle 11, and a network 13 forming a cell phone network or a public telephone line network, and an emergency service center (may be simplified as a “center”) 14. In an emergency situation, the vehicle 11 and the center 14 are in contact with each other through the network 13, so that an occupant in the vehicle 11 and an operator in the center 14 may talk with each other. Further, when it becomes necessary, the operator of the center 14 is in contact with the fire department 15, the police 16, or an emergency road service provider 17 to ask to immediately move to the site of the vehicle 11.

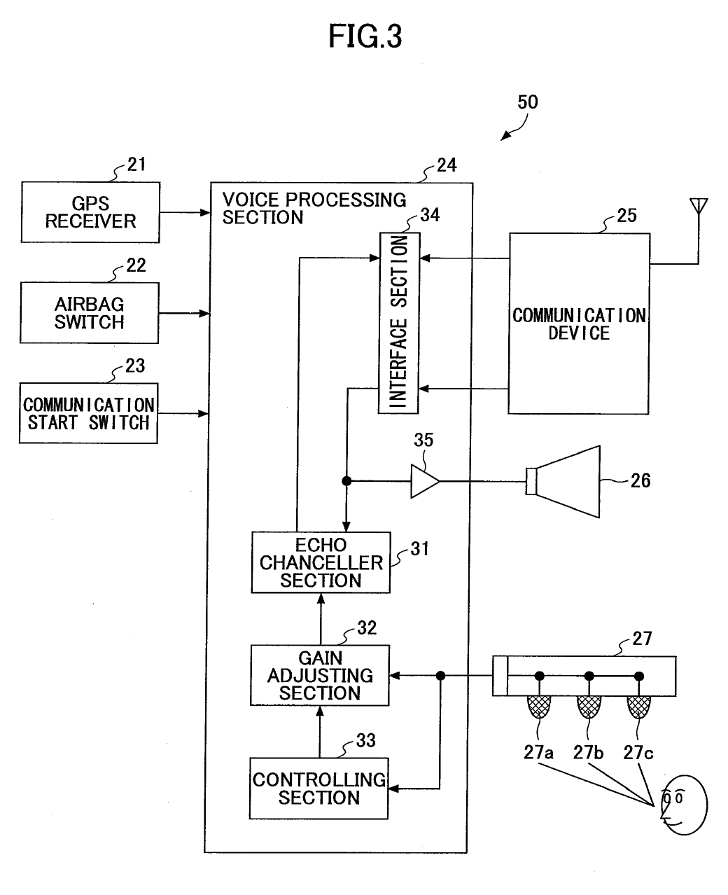

FIG. 3 is a block diagram showing an exemplary configuration of the emergency call device 50. As shown in FIG. 3, the emergency call device 50 includes a voice processing section 24 controlling the emergency call device 50. Further, the voice processing section 24 is connected to a GPS (Global Positioning System) receiver 21, an airbag switch 22, a communication start switch 23, a communication device 25, a speaker 26, and microphones 27. The GPS receiver 21 receives radio waves from GPS satellites for calculating the position of the vehicle 11. The airbag switch 22 detects an operation of airbags housed in the driver's seat, a front passenger's seat, and the like. The communication start switch 23 is turned ON by an occupant of the vehicle 11 to start communication with the center 14. The communication device 25 is provided for the communications with the center 14. The speaker 26 outputs a voice, and the microphone array 27 picks up the voice and converts the voice into an electrical signal.

The voice processing section 24 is a computer including a CPU, a ROM, a RAM and input/output interfaces. Further, the voice processing section 24 includes an interface section 34 inputting and outputting a received voice signal and a transmitted voice signal with the communication device 25, an echo canceller section 31 canceling an echo of the voice, a gain adjusting section 32 adjusting a gain of the transmitted voice signal from the microphone array 27, and a controlling section 33 controlling the gain adjusting section 32.

The communication device 25 may be a data communication unit having a voice communication function, or a cell phone of an occupant of the vehicle 11. When the communication device 25 performs a data communication, the communication device 25 establishes a data link connection in accordance with the PPP (Point-To-Point) protocol or the like and can transmit and receive data through the network 13, using an upper layer protocol such as TCP/IP (Transmission Control Protocol/Internet Protocol). Through the communication device 25, the positional information of the vehicle 11 may be transmitted to the center 14.

The interface section 34 establishes a connection with the communication device 25 based on a wiring connection removably attached to or a wireless communication with the communication device 25, so that the interface section 34 receives the received voice signal transmitted from the communication device 25 and transmits the transmitted voice signal to the communication device 25, the transmitted voice signal being generated in the voice processing section 24. When the wireless communication is performed, the Bluetooth (registered trademark) communication standards may be used for receiving and transmitting the received voice signal and the transmitted voice signal.

Further, the interface section 34 may be equipped with an input device (not shown) such as a switch so that a user can operate the input device to transmit an On-hook/Off-hook instruction to the communication device 25 to operate the communication device 25 to perform an On-hook/Off-hook operation.

Further, in an emergency situation, when the airbag switch 22 detects an operation of the airbag of the vehicle 11, or when the communication start switch 23 is turned ON, the interface section 34 sets a telephone number previously registered as the destination telephone number so as to call the center 14. In addition, an emergency situation may be detected by using an acceleration sensor in the vehicle 11 or the like.

The communication device 25 transmits the received voice signal to the interface section 34, the received voice signal being received from the operator of the center 14 through the network 13. Further, the communication device 25 transmits the transmitted voice signal to the operator through the network 13, the transmitted voice signal being received from the interface section 34.

The voice processing section 24 further includes a received voice amplifier 35. The received voice amplifier 35 amplifies the received voice signal transmitted from the interface section 34 and drives the speaker 26 to output the received voice in the vehicle 11. As the speaker 26, a speaker for an audio system or a navigation system installed in the vehicle 11 may be used. Preferably, for example, the speaker 26 is embedded in the driver's door and is directed inward.

The echo canceller section 31 cancels the received voice signal which outputs from the speaker 26 and inputs into the microphone array 27. More specifically, the echo canceller section 31 subtracts a pseudo echo signal from the transmitted voice signal from the gain adjusting section 32 and transmits the subtracted result to the interface section 34, the pseudo echo signal being calculated by inverting the phase of the received voice signal by 180 degrees and modifying in accordance with the expected changes based on the ambient acoustic characteristics.

The microphone array 27 is a voice detector, and in the normal conversational situation, has the narrow directional area so that the voice-collection area of the microphone array 27 is directed toward the mouth of the driver of the vehicle 11 as shown in FIG. 1B. In this embodiment, the microphone array 27 includes plural microphones 27a through 27c arranged in an arrayed form. In FIG. 3, for explanation purposes, those microphones 27a through 27c are arranged in a line.

The gain adjusting section 32 includes electronic volumes (not shown) for adjusting each of the outputs from the microphones 27a through 27c so that, for example, the voice-collection area of the microphone array 27 is reduced to be the narrow directional area directed to the mouth of the driver of the vehicle 11. The controlling section 33 detects the direction toward the mouth of the driver based on each output level and delay time of the microphones 27a through 27c, and controls the gain adjusting section 32 so that the microphones 27a through 27c (namely, as the microphone array 27) has a desired voice-collection area.

A method of detecting the direction toward the mouth of the driver is described in more detail. When a voice of the driver is received by the three microphones 27a through 27c, the microphones 27a through 27c detect the signal levels “Va”, “Vb”, and “Vc” (or simply “V” when the level is not required to be distinguished from each other) and the delay time “ta”, “tb”, and “tc” (or simply “t” when each delay time is not required to be distinguished), respectively, of the voice. Herein, the delay time “t” is a relative value by setting any of the microphones 27a through 27c as a reference microphone. In a case where the output characteristics of the microphones 27a through 27c are substantially the same and each gain of the outputs of the microphones is not adjusted, the signal level “V” decreases and the delay time “t” increases in proportion to the distance between the microphones 27a through 27c and the mouth of the driver. Further, distances and directions between the microphones 27a through 27c are known. Therefore, the direction from the microphone array 27 to the mouth of the driver can be calculated from the signal level “V” and delay time “t”.

Next, a method of controlling (adjusting) the directional area (voice-collection area) of the microphone array 27 is described. The directional area is determined by adjusting gains “Ga”, “Gb”, and “Gc” (or simply “G” when each gain is not required to be distinguished) of the microphones 27a through 27c, respectively. For example, when it is detected that the mouth of the driver is positioned closer to the microphone 27c than to the other microphones, the gains “Ga”, “Gb”, and “Gc” are adjusted so that the values of the gains increase in the order of “Ga”, “Gb”, and “Gc” (i.e., Ga<Gb<Gc). By doing this, the voice-collection area of the microphone array 27 may be narrowed with respect to the direction toward the mouth of the driver.

Further, when the relative relationships between the gains “Ga”, “Gb”, and “Gc” are adjusted, it becomes possible to control (widen or narrow) the width of the voice-collection. It should be noted that previous adjusted value of the gain “G” of the directional area where the voice of the driver may be clearly picked up may be stored in the controlling section 33 as values used just before the ignition is turned OFF.

As described above, by making the directional area (directionality) of the microphone array 27 direct toward the mouth of the driver and by maintaining the directionality of the microphone array 27 in other directions at a low level, the road noise level picked up by the microphone array 27 may be lowered, and accordingly the voice of the driver may be picked up effectively. On the other hand, when the gains “Ga”, “Gb”, and “Gc” are not adjusted, the directionality of the microphone array 27 may be reduced and the voice of the driver can be picked up from a wider voice-collection area.

The microphone array 27 may be embedded into the ceiling of a vehicle interior and directed toward the inside of the vehicle 11. The microphone array 27 may also be embedded into the center portion of the steering wheel, or an instrument panel, an A-pillar on the driver's side, or the like. Namely, each of the microphones 27a through 27c of the microphone array 27 may be disposed in different positions separated from each other in the vehicle 11.

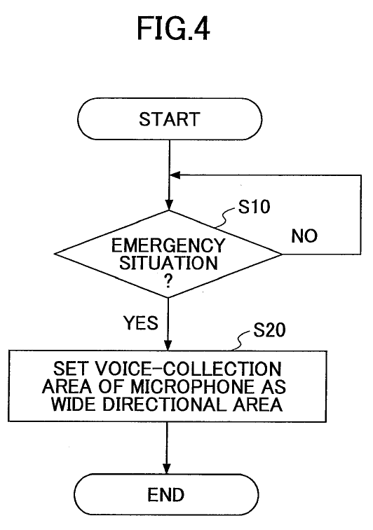

Next, a process of adjusting the directional area by the voice processing section 24 is described with reference to the flowchart in FIG. 4. The flow of the flowchart in FIG. 4 starts when, for example, the ignition of the vehicle 11 is turned ON.

When the ignition is turned ON, the voice processing section 24 determines whether it is in an emergency situation (step S10). For example, when the airbag switch 22 or the communication start switch 23 is turned ON, it is determined that it is in an emergency situation. It should be noted that when an occupant of the vehicle 11 does not or is unable to talk to an operator of the emergency service center (“center”) 14 using the speaker 26 and the microphone array 27, it is not necessary to adjust the directional area.

In an emergency situation, the controlling section 33 widens the voice-collection area of the microphone array 27 so that directional area becomes the wide directional area (step S20). By widening the voice-collection area to become the wide directional area, the voice from the driver may be picked up more clearly even when the position of the mouth of the driver who may be involved in an accident is uncertain.

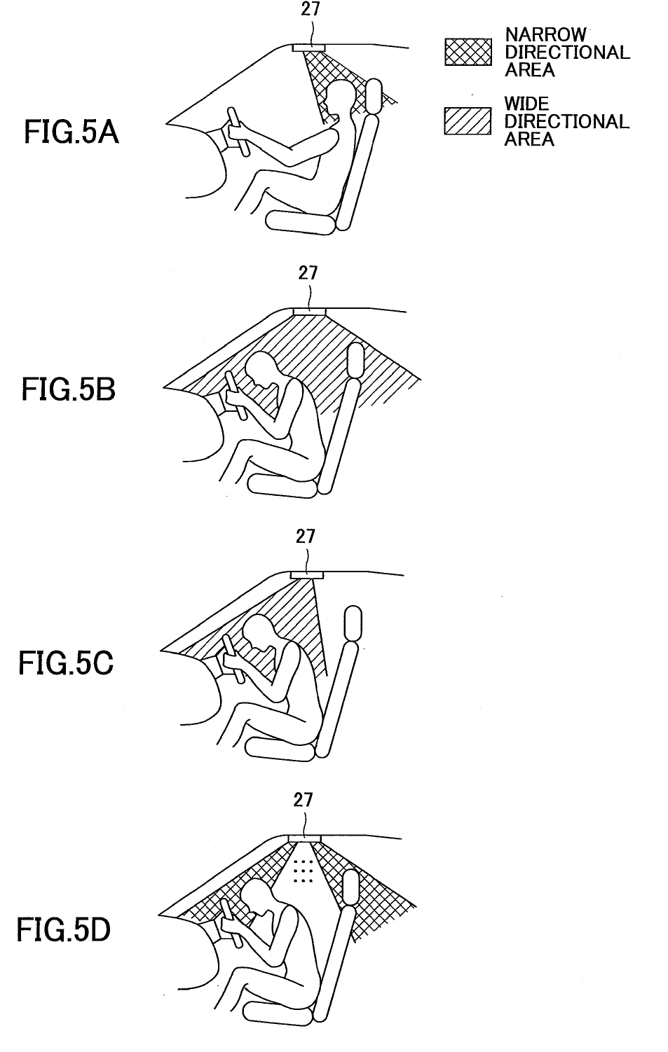

FIGS. 5B and 5C show examples of wide directional areas in an emergency situation. On the other hand, FIG. 5A shows an example of the narrow directional area in the normal conversational situation. FIG. 5B shows an omnidirectional area when any of the gains “Ga”, “Gb”, and “Gc” of the microphones 27a through 27c is not adjusted. Therefore, the microphone array 27 has a wider directional area (voice-collection area). By doing this, it becomes possible for the microphone array 27 to pick up the voice of the driver from the mouth of the driver because the directional area (voice-collection area) may cover a range from the mouth position of the driver when the driver is in the normal conversational situation to the mouth position of the driver when the driver bends his/her head over the steering wheel.

FIG. 5C shows a wide directional area when only the microphone 27a located on the front end side is used to pick up the voice of the driver. In this case, for example, the gain “Ga” of the microphone 27a is set at a prescribed value, and values of the other gains “Gb” and “Gc” of the microphone 27b and 27c are zero (0). When this wide directional area as shown in FIG. 5C is formed, a voice of the driver who bends his/her head over the steering wheel may be clearly picked up.

FIG. 5D shows a wide directional area which is obtained as a result by, for example, moving (scanning) the narrow directional area over time. In this case, the narrow directional area (voice-collection area) of the microphone array 27 is moved (scanned) to cover a range from the mouth position of the driver when the driver is in the normal conversational situation to the mouth position of the driver when the driver bends his/her head over the steering wheel. As a result, even when the volume of the voice of the driver is low due to an accident, the voice of the driver may be picked up clearly when the narrow directional area of the microphone array 27 moves to the position covering the position of the mouth of the driver.

When the driver speaks, the controlling section 33 may detect the voice of the driver by detecting a signal level “V” from the microphone 33. Therefore, by fixing the values of the gains “Ga”, “Gb”, and “Gc” when the voice of the driver is detected, the voice from the driver whose position is uncertain may be picked up effectively with the narrow directional area.

In the emergency call device 50 according to an embodiment of the present invention, in an emergency situation, by widening the voice-collection area of the microphone array 27, it may become possible to pick up the voice of the driver clearly even when the position of the driver is different from that in the normal conversational situation.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teachings herein set forth.

What is claimed is:

1. A vehicle call device comprising:
a speaker installed in a vehicle, the speaker outputting a received voice of an opposite party;
a microphone installed in the vehicle, the microphone picking up a voice of an occupant of the vehicle;
a detecting unit detecting an emergency situation of the vehicle; and
a controlling unit, when the detecting unit detects the emergency situation, controlling directional characteristics of the microphone so that the voice can be picked up from an area wider than an area provided before the emergency situation is detected.

2. A vehicle call device comprising:
a speaker installed in a vehicle, the speaker outputting a received voice of an opposite party;
a microphone installed in the vehicle, the microphone capable of adjusting directional characteristics of the microphone so that a voice of an occupant of the vehicle can be picked up;
a detecting unit detecting an emergency situation of the vehicle; and
a controlling unit, when the detecting unit detects the emergency situation, controlling the directional characteristics of the microphone so that the voice can be picked up from an area including an area different from an area provided before the emergency situation is detected.

3. The vehicle call device according to claim 1, wherein
when the detecting unit detects an emergency situation, the controlling unit controls the directional characteristics of the microphone so that the voice can be picked up from an area near a steering wheel of the vehicle.

4. The vehicle call device according to claim 2, wherein
when the detecting unit detects an emergency situation, the controlling unit controls the directional characteristics of the microphone so that the voice can be picked up from an area near a steering wheel of the vehicle.

5. The vehicle call device according to claim 1, wherein
when the detecting unit detects an emergency situation, the controlling unit controls the directional characteristics of the microphone so that the microphone has omnidirectional characteristics.

6. A calling method for a vehicle call device including
a speaker installed in a vehicle, the speaker outputting a received voice of an opposite party, and
a microphone installed in the vehicle, the microphone picking up a voice of an occupant of the vehicle, the method comprising:
a detecting step of detecting an emergency situation of the vehicle; and
a controlling step of, when the detecting unit detects the emergency situation, controlling directional characteristics of the microphone so that the voice can be picked up from an area wider than an area provided before the emergency situation is detected.
